(19) United States
(12) Patent Application Publication
(10) Pub. No.: US 2020/0131950 A1
(43) Pub. Date: Apr. 30, 2020

(54) METHODS OF SETTING A TAPPET IN AN ENGINE

(71) Applicant: Honda Motor Co., Ltd., Tokyo (JP)

(72) Inventors: Bartley K. Merriam, Botkins, OH (US); Richard Moldas, Bellefontaine, OH (US)

(21) Appl. No.: 16/169,546

(22) Filed: Oct. 24, 2018

(51) Int. Cl. F01L 1/20

(52) U.S. Cl. CPC F01L 1/20; G01B 5/0032

(57) ABSTRACT

A method of setting a tappet in an engine. The method includes setting a crankshaft at a predetermined crankshaft rotation angle. A cam coupled to the crankshaft is configured to provide cam lobe lift when the crankshaft is set at the predetermined crankshaft rotation angle. The cam lobe lift translates a tappet screw, coupled to the cam, towards a valve by a distance less than a gap defined between the valve and the tappet screw. The method also includes adjusting the tappet screw such that a zero gap tappet clearance is defined between the valve and the tappet screw.

### BACKGROUND

The field of the present disclosure relates generally to internal combustion engines and, more specifically, to methods of setting a tappet in an engine or other mechanical assembly.

At least some known engines include a rocker arm operably connected to a valve mechanism. In operation, the engine intakes fuel gas and discharges exhaust gas as valves of the valve mechanism are actuated into an open position by an adjustment screw on the distal end of the rocker arm. The rocker arm is typically actuated by a cam, and the valves are returned to a closed position by a spring when the rocker arm returns to a neutral position. A clearance (hereinafter referred to as a tappet clearance) is defined between an end of the valve and the adjustment screw. The adjustment screw is adjusted to enable the valve to fully close when the rocker arm returns to the neutral position. If the tappet clearance is too small, thermal expansion may reduce or eliminate the tappet clearance at high engine temperatures, thereby resulting in unintentional actuation of the valves. However, if the tappet clearance is too large, the valve end and the adjustment screw produce a loud noise when they contact each other. As such, the tappet clearance is typically set to an optimal clearance distance during assembly of the engine.

Setting the tappet clearance typically includes rotating the engine to an orientation such that a piston cylinder is at top dead center and associated valves are in the closed position. A tappet clearance should be defined between the adjustment screw and the valve end in this orientation, and the tappet clearance may be adjusted using a feeler gauge. For example, the gauge has a thickness substantially equal to the optimal clearance distance, and the feeler gauge is used to calibrate the tappet clearance. The process is then repeated for the other engine valves. However, setting tappet clearances in this manner is time-consuming, laborious, and potentially inaccurate. In addition, readjusting misset tappet clearances increases assembly costs and labor.

### BRIEF DESCRIPTION

In one aspect, a method of setting a tappet in an engine is provided. The method includes setting a crankshaft at a predetermined crankshaft rotation angle. A cam coupled to the crankshaft is configured to provide cam lobe lift when the crankshaft is set at the predetermined crankshaft rotation angle. The cam lobe lift translates a tappet screw, coupled to the cam, towards a valve by a distance less than a gap defined between the valve and the tappet screw. The method also includes adjusting the tappet screw such that a zero gap tappet clearance is defined between the valve and the tappet screw.

In another aspect, a method of setting a tappet in an engine is provided. The method includes defining a predetermined tappet clearance value, determining a cam profile of a cam, wherein the cam profile is determined as a function of cam lobe lift and camshaft rotation angle. The method also includes determining a camshaft rotation angle for a camshaft, coupled to the cam, that facilitates producing a cam lobe lift value approximately equal to the predetermined tappet clearance value, and determining a crankshaft rotation angle that corresponds to the camshaft rotation angle.

In yet another aspect, a method of setting a tappet in an engine is provided. The method includes adjusting a tappet screw coupled to a cam such that a gap defined between a valve and the tappet screw is greater than a predetermined tappet clearance, and setting a crankshaft at a predetermined crankshaft rotation angle. The cam is coupled to the crankshaft, the cam is configured to provide cam lobe lift when the crankshaft is set at the predetermined crankshaft rotation angle, and the cam lobe lift translates the tappet screw towards the valve by a distance less than the gap. The method also includes adjusting the tappet screw such that a zero gap tappet clearance is defined between the valve and the tappet screw, wherein the predetermined tappet clearance is defined between the valve and the tappet screw when the cam does not provide the cam lobe lift

### BRIEF DESCRIPTION OF THE DRAWINGS

FIG. 1 is cross-sectional view of an exemplary internal combustion engine.

FIG. 2 is a perspective view of an overhead cam assembly that may be used in the internal combustion engine shown in FIG. 1.

FIG. 3 is a schematic view of a portion of the overhead cam assembly shown in FIG. 2 at a first rotation angle.

FIG. 4 is a schematic view of a portion of the overhead cam assembly shown in FIG. 3 at a second rotation angle.

FIG. 5 is a schematic view of a portion of the overhead cam assembly shown in FIG. 4 at a third rotation angle.

FIG. 6 is a schematic view of a portion of the overhead cam assembly shown in FIG. 5 at a fourth rotation angle.

FIG. 7 a graphical representation of a cam profile of a cam that may be used in the overhead cam assembly shown in FIGS. 3-6.

FIG. 8 is an enlarged graphical representation of a first portion of the cam profile shown in FIG. 7.

FIG. 9 is an enlarged graphical representation of a second portion of the cam profile shown in FIG. 7.

FIG. 10 is a schematic view of a portion of the overhead cam assembly shown in FIG. 2 at the second rotation angle.

FIG. 11 is a flowchart illustrating an exemplary method of setting a tappet.

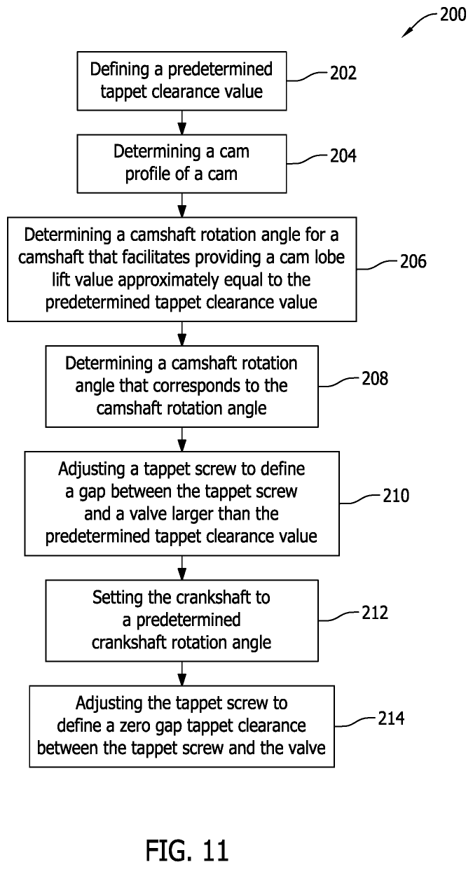

### DETAILED DESCRIPTION

The embodiments described herein relate generally to a method of setting a tappet in an engine or other mechanical assembly. More specifically, the method includes setting a tappet when a camshaft is at a rotation angle that produces minimal cam lobe lift. For example, a cam coupled to the camshaft includes a cam lobe defined, in sequential rotation, by a heel, an opening ramp, a nose, a closing ramp, and then the heel once again. A gap is defined between the tappet and a valve stem when the cam engages a rocker arm, for example, at the heel of the cam lobe. Cam lobe lift that facilitates closing the gap is produced when the cam engages the rocker arm at the ramp locations of the cam lobe. In the method described herein, a tappet is initially set such that the gap is larger than a predetermined tappet clearance to be set for the tappet. The cam is then rotated until the rocker arm engages one of the ramp locations on the cam. More specifically, the cam is rotated to an angle that will produce cam lobe lift approximately equal to the predetermined tappet clearance. The tappet is then adjusted to close the gap between the tappet and the valve stem, thereby setting the position of the tappet. As such, the tappet position is set without the use of a thickness gauge, which facilitates increasing the accuracy of the tappet position and reducing the need to reset misset tappets. In addition, the method described herein enables setting the tappet position in an automated manner without human intervention.

As used herein, an element or step recited in the singular and preceded with the word “a” or “an” should be understood as not excluding plural elements or steps, unless such exclusion is explicitly recited. Furthermore, references to “exemplary implementation” or “one implementation” of the present disclosure are not intended to be interpreted as excluding the existence of additional implementations that also incorporate the recited features.

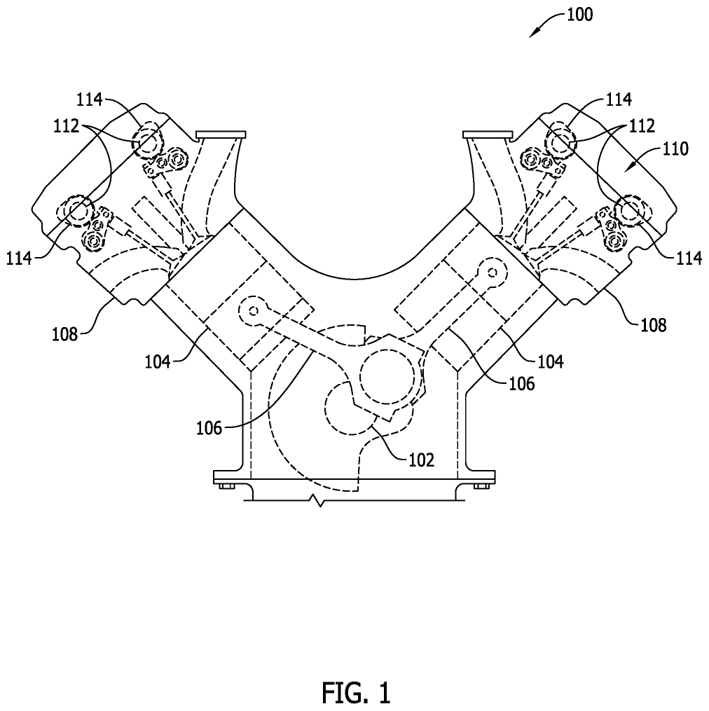

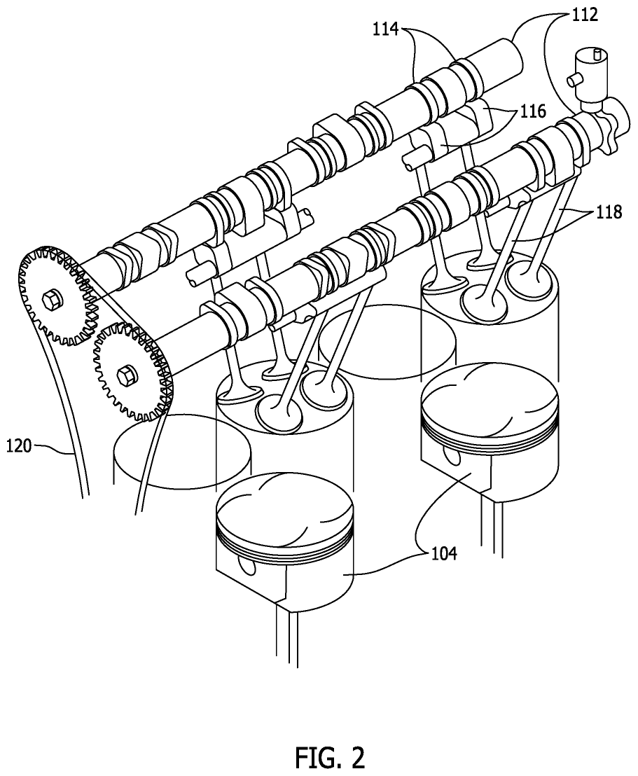

FIG. 1 is cross-sectional view of an exemplary internal combustion engine 100, and FIG. 2 is a perspective view of an overhead cam assembly internal combustion engine 100. In the exemplary embodiment, internal combustion engine 100 includes a crankshaft 102, pistons 104, and connecting rods 106 extending between crankshaft 102 and pistons 104. Internal combustion engine 100 further includes a cylinder head 108 and an overhead cam assembly 110 positioned within cylinder head 108. Overhead cam assembly 110 includes camshafts 112 that extend parallel with crankshaft 102, a plurality of cams 114 coupled to camshafts 112, a plurality of rocker arms 116 operably coupled to cams 114, and a plurality of valves 118 operably coupled to rocker arms 116. In an alternative embodiment, rocker arms 116 are omitted from overhead cam assembly 110, and cams 114 are operably coupled to valves 118. As shown in FIG. 2, crankshaft 102 is operably coupled to camshafts 112 with a timing belt 120. In one embodiment, a ratio of crankshaft rotation to camshaft rotation is about 2-to-1.

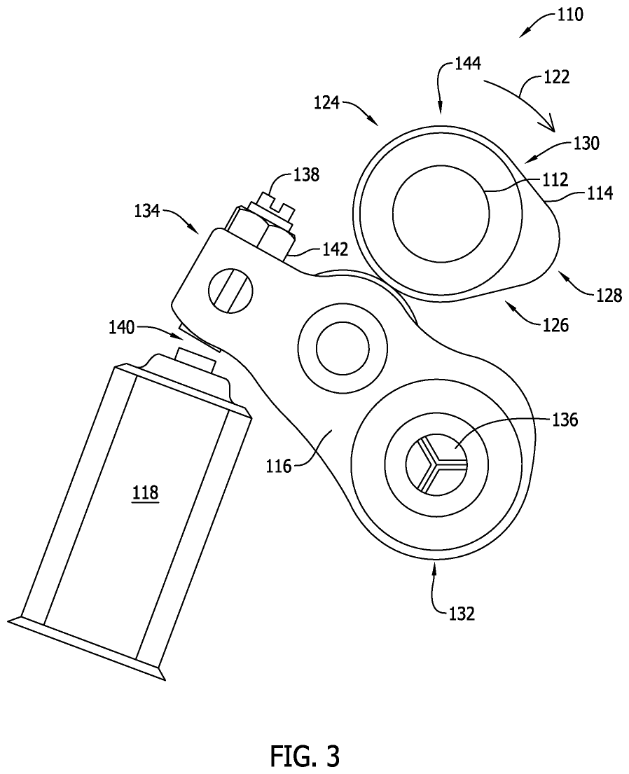

FIGS. 3-6 are illustrations of overhead cam assembly 110 with camshaft 112 positioned at various rotation angles. In the exemplary embodiments, cam 114 is rotatable in a rotational direction 122, and includes a heel 124, an opening ramp 126, a nose 128, and a closing ramp 130 in sequential rotation. Rocker arm 116 includes a first end 132 and a second end 134. Rocker arm 116 is rotatable about a pivot point 136 defined in first end 132, and includes a tappet screw 138 operably coupled thereto at second end 134. When rotated, tappet screw 138 is movable towards or away from valve 118 to facilitate decreasing or increasing a gap 140 (i.e., a tappet clearance) defined therebetween. A lock nut 142 is coupled to tappet screw 138, and lock nut 142 facilitates securing tappet screw 138 when in a desired position.

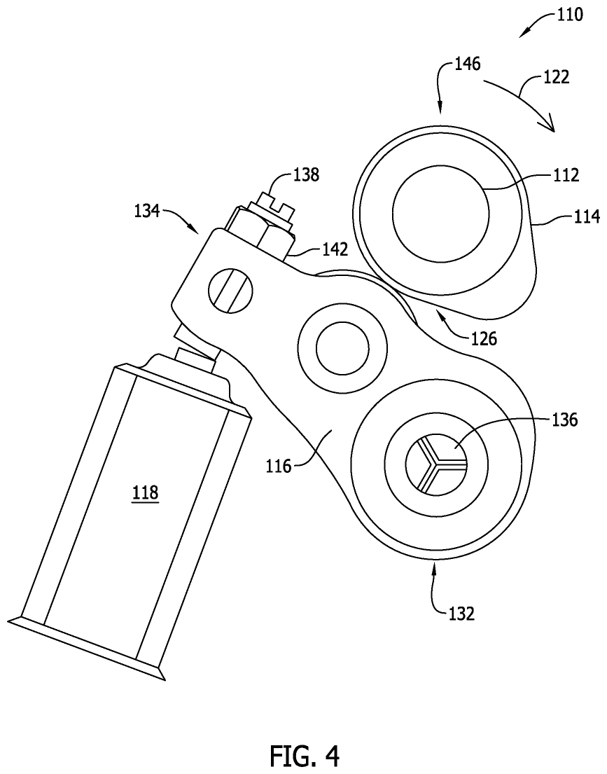

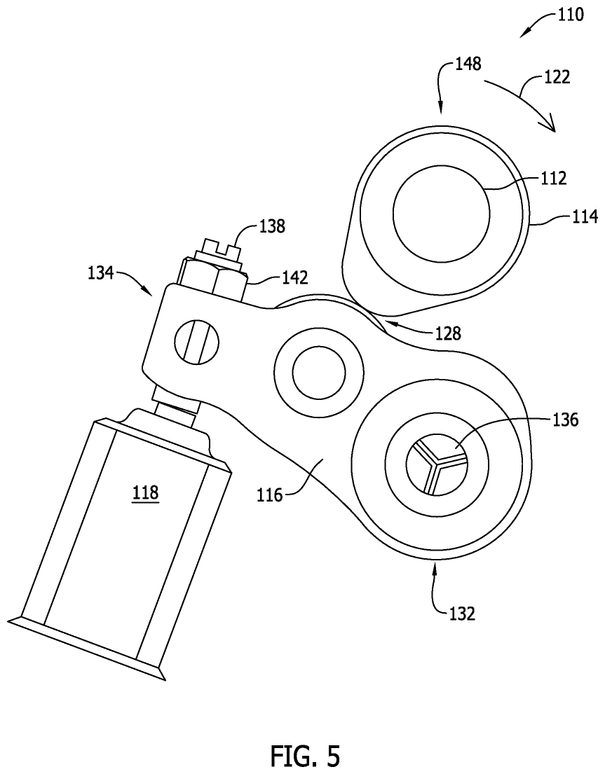

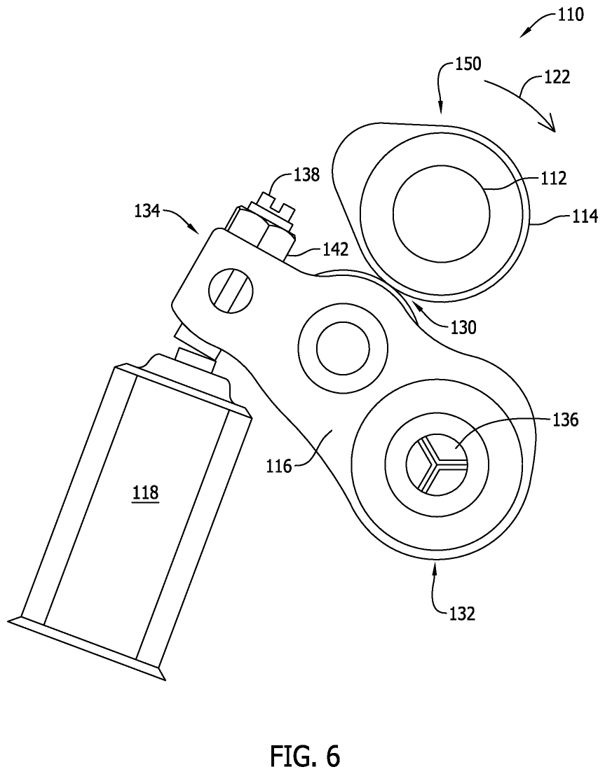

Referring to FIG. 3, camshaft 112 is rotated to a first rotation angle 144 in which heel 124 is engaged with rocker arm 116 such that gap 140 is defined between valve 118 and tappet screw 138. As such, tappet screw 138 is not engaged with valve 118 and valve 118 is in a closed position when camshaft 112 is at first rotation angle 144. Referring to FIG. 4, camshaft 112 is rotated to a second rotation angle 146 in which a portion of opening ramp 126 is engaged with rocker arm 116. Minimal cam lobe lift is provided when camshaft 112 is rotated to second rotation angle 146. As such, tappet screw 138 is engaged with valve 118 such that a zero gap tappet clearance is defined therebetween, but valve 118 remains in the closed position when camshaft 112 is at second rotation angle 146. Referring to FIG. 5, camshaft 112 is rotated to a third rotation angle 148 in which nose 128 is engaged with rocker arm 116. Cam lobe lift progressively increases when camshaft 112 is rotated from second rotation angle 146 to third rotation angle 148. As such, tappet screw 138 is engaged with valve 118, and valve 118 is moved to an open position as camshaft 112 is rotated from second rotation angle 146 to third rotation angle 148. Referring to FIG. 6, camshaft 112 is rotated to a fourth rotation angle 150 in which a portion of closing ramp 130 is engaged with rocker arm 116. Cam lobe lift progressively decreases when camshaft 112 is rotated from third rotation angle 148 to fourth rotation angle 150, and minimal cam lobe lift is provided when camshaft 112 is positioned at fourth rotation angle 150. As such, tappet screw 138 is engaged with valve 118 such that a zero gap tappet clearance is defined therebetween, and valve 118 is returned to the closed position.

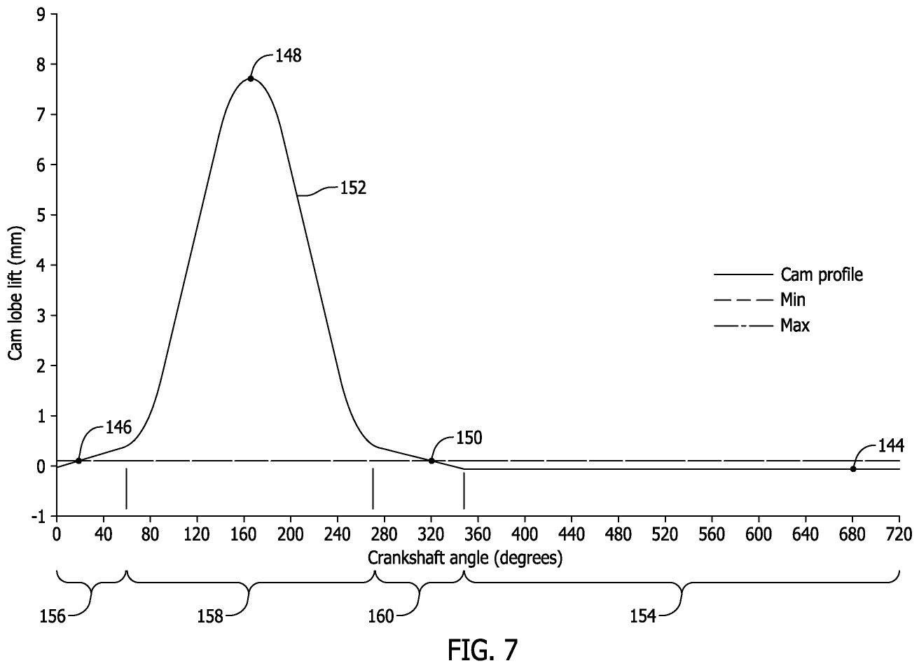

FIGS. 7-9 are graphical representations of a cam profile 152 of cam 114 (shown in FIGS. 3-6), for example. Cam profile 152 is determined by performing a linear variable differential transformer analysis on the outer surface of cam 114 as cam 114 is rotated 360 degrees. In the exemplary embodiment, cam profile 152 is defined as a function of crankshaft rotation angle, in degrees, and cam lobe lift, in millimeters (mm). Alternatively, cam profile 152 may be defined as a function of camshaft rotation angle and cam lobe lift based on the known ratio of crankshaft rotation to camshaft rotation (i.e., about 2-to-1). Cam profile 152 is defined by a plurality of zones that are each defined by a range of crankshaft rotation angles that correspond to the features of cam 114. For example, the plurality of zones include a heel zone 154, an opening ramp zone 156, a nose zone 158, and a closing ramp zone 160. As such, first rotation angle 144 is defined in heel zone 154, second rotation angle 146 is defined in opening ramp zone 156, third rotation angle 148 is defined in nose zone 158, and fourth rotation angle 150 is defined in closing ramp zone 160.

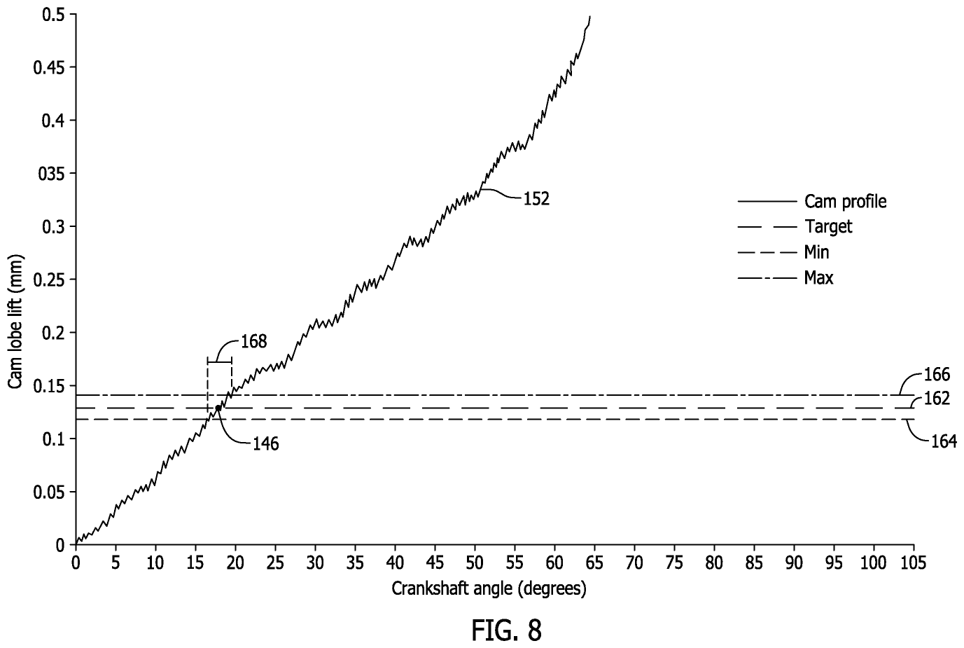

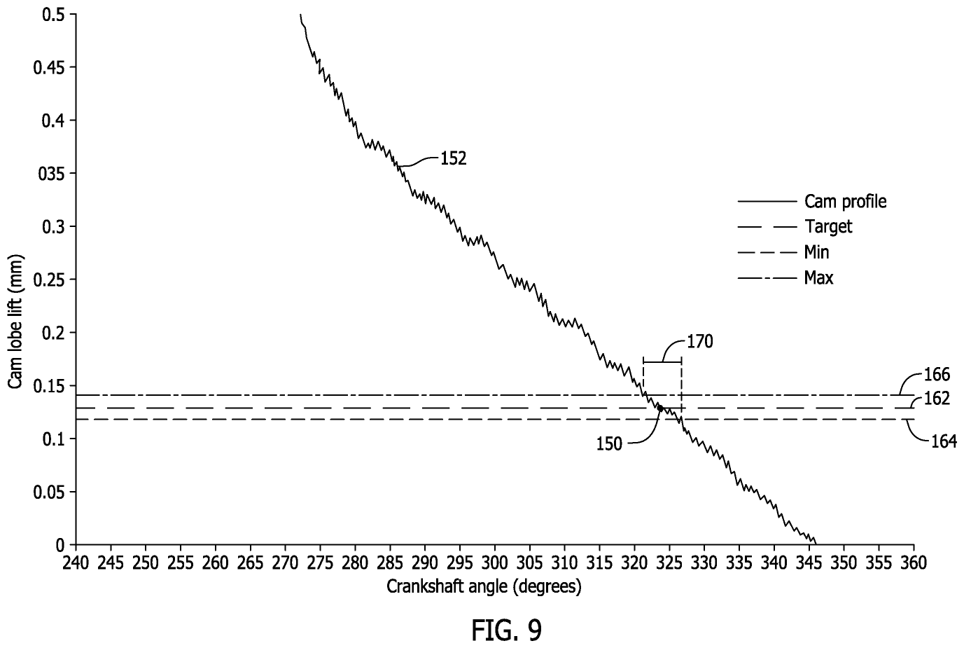

Referring to FIGS. 8 and 9, a target lift line 162, a minimum lift line 164, and a maximum lift line 166 are defined on the graphical representations. Target lift line 162 represents a target cam lobe lift value approximately equal to a predetermined tappet clearance. The predetermined tappet clearance value is a target distance to be set for gap 140 (shown in FIG. 3) that will result in proper assembly of overhead cam assembly 110 (shown in FIG. 1). Minimum and maximum lift lines 164 and 166 represent minimum and maximum cam lobe lift values that will enable the target cam lobe lift value to be achieved within a predefined tolerance. As such, referring to FIG. 8, a first window 168, defined by a first range of crankshaft rotation angles, is defined in opening ramp zone 156. In addition, referring to FIG. 9, a second window 170, defined by a second range of crankshaft rotation angles, is defined in closing ramp zone 160. The size of first window 168 and second window 170 is determined as a function of cam profile 152 (i.e., the shape of cam 114). As such, in one embodiment, first window 168 is smaller than second window 170. For example, in the exemplary embodiment, first window 168 is defined by a 4° crankshaft rotation angle range (i.e., a 2° camshaft rotation angle range), and second window 170 is defined by a 6° crankshaft rotation angle range (i.e., a 3° camshaft rotation angle range).

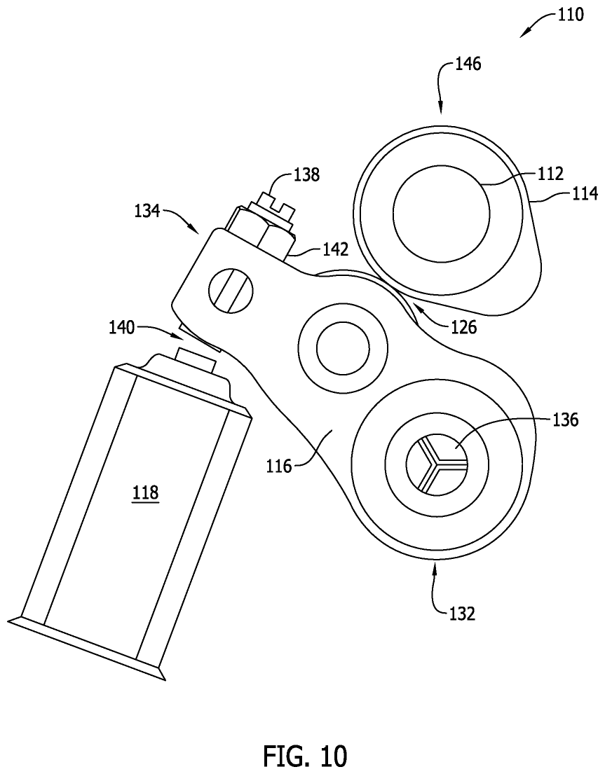

FIG. 10 illustrates an exemplary method 200 of setting a tappet. The method 200 includes defining 202 a predetermined tappet clearance value, and determining 204 cam profile 152, both as discussed above. The method 200 further includes determining 206 a camshaft rotation angle for camshaft 112 that facilitates providing a cam lobe lift value approximately equal to the predetermined tappet clearance value. A crankshaft rotation angle is then determined 208 that corresponds to the camshaft rotation angle. As such, crankshaft 102 (shown in FIG. 1) may be utilized to position cam 114 at the various rotation angles when crankshaft 102 is operably coupled to camshaft 112.

In the exemplary embodiment, tappet screw 138 is adjusted 210 such that gap 140 is larger than the predetermined tappet clearance. Crankshaft 102 is then set 212 to a predetermined crankshaft rotation angle, such as a crankshaft rotation angle that positions camshaft 112 at second rotation angle 146. Alternatively, crankshaft 102 is set 212 to a crankshaft rotation angle that positions camshaft at fourth rotation angle 150 (shown in FIG. 6). Piston 104 (shown in FIG. 1) is offset from top dead center when camshaft 112, and crankshaft 102, is set at second rotation angle 146 and fourth rotation angle 150.

The predetermined crankshaft rotation angle is configured to produce the cam lobe lift value approximately equal to the predetermined tappet clearance value. Cam 114 is configured to provide cam lobe lift when crankshaft 102 is set to the predetermined crankshaft rotation angle. The cam lobe lift is configured to translate tappet screw 138 towards valve 118 by a distance less than gap 140. Tappet screw 138 is then adjusted 214 such that a zero gap tappet clearance is defined between valve 118 and tappet screw 138, as illustrated in FIG. 4. Tappet screw 138 is then secured in position with lock nut 142.

In the exemplary embodiment, rocker arm 116 is operably coupled between cam 114 and valve 118. Rocker arm 116 is a lever that facilitates increasing valve lift relative to cam lobe lift. As such, in one embodiment, the method described herein includes determining a rocker arm ratio for rocker arm 116, and determining the camshaft and crankshaft rotation angles, configured to produce the cam lobe lift value approximately equal to the predetermined tappet clearance value, as a function of the rocker arm ratio.

The methods described herein include facilitate setting a tappet in an efficient and accurate manner that is easily repeatable. For example, the methods described herein facilitate setting a tappet without the use of a thickness gauge, which facilitates increasing the accuracy of the tappet position and reducing the need to reset misset tappets. In addition, the method enables setting the tappet position in an automated manner without human intervention. As a result, costs and labor associated with engine assembly are reduced.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of setting a tappet in an engine, the method comprising:
setting a crankshaft within a first range of crankshaft rotation angles, wherein a cam coupled to the crankshaft is configured to provide cam lobe lift when the crankshaft is set within the first range of crankshaft rotation angles, and wherein the cam lobe lift translates a tappet screw, coupled to the cam, towards a valve by a distance less than a gap defined between the valve and the tappet screw, wherein the distance corresponds to a predetermined tappet clearance value defined when the crankshaft is set within a second range of crankshaft rotation angles; and
adjusting the tappet screw such that a zero gap tappet clearance is defined between the valve and the tappet screw.

2. The method in accordance with claim 1, wherein setting the crankshaft comprises:
defining a predetermined tappet clearance value;
determining a cam profile of the cam as a function of cam lobe lift and camshaft rotation angle;
determining a target camshaft rotation angle for a camshaft that facilitates producing a cam lobe lift value equal to the predetermined tappet clearance value; and
determining a target crankshaft rotation angle that corresponds to the camshaft rotation angle.

3. The method in accordance with claim 2 further comprising determining the target crankshaft rotation angle based on a ratio of crankshaft rotation to camshaft rotation.

4. The method in accordance with claim 2, wherein determining the target camshaft rotation angle comprises determining the target camshaft rotation angle range that facilitates producing the cam lobe lift value.

5. The method in accordance with claim 4, wherein determining the target camshaft rotation angle range comprises determining a first camshaft rotation angle range that corresponds to an opening ramp of the cam.

6. The method in accordance with claim 4, wherein determining the target camshaft rotation angle range comprises determining a second camshaft rotation angle range that corresponds to a closing ramp of the cam.

7. The method in accordance with claim 2, wherein the engine also includes a rocker arm operably coupled to the cam, the method further comprising:
determining a rocker arm ratio for the rocker arm; and
determining the target camshaft rotation angle as a function of the rocker arm ratio.

8. The method in accordance with claim 7, wherein the tappet screw is coupled to the rocker arm, the method further comprising determining the target camshaft rotation angle that facilitates translating the tappet screw towards the valve by a distance equal to the predetermined tappet clearance value.

9. The method in accordance with claim 2, wherein determining the cam profile of the cam further comprises performing a linear variable differential transformer analysis on an outer surface of the cam.

10. The method in accordance with claim 1, wherein adjusting the tappet screw comprises adjusting the tappet screw before setting the crankshaft, wherein the tappet screw is adjusted such that the gap is greater than a predetermined tappet clearance.

11. The method in accordance with claim 1 further comprising securing the tappet screw after the adjusting of the tappet screw is complete.

12. The method in accordance with claim 1, wherein the engine includes a piston operably coupled to the crankshaft, the method further comprising setting the crankshaft at an angle such that the piston is offset from top dead center at the predetermined crankshaft rotation angle.

13. A method of setting a tappet in an engine, the method comprising:
defining a predetermined tappet clearance value;
determining a cam profile of a cam as a function of cam lobe lift and camshaft rotation angle;
determining a range of target camshaft rotation angles for a camshaft, coupled to the cam, that facilitates producing a cam lobe lift value equal to the predetermined tappet clearance value; and
determining a range of crankshaft rotation angles that corresponds to the range of target camshaft rotation angles.

14. The method in accordance with claim 13 further comprising determining the range of crankshaft rotation angles based on a ratio of crankshaft rotation to camshaft rotation.

15. The method in accordance with claim 13, wherein determining the range of target camshaft rotation angles comprises determining range of target camshaft rotation angles defined by a minimum cam lobe lift value and a maximum cam lobe lift value for producing cam lobe lift equal to the predetermine tappet clearance value within a tolerance.

16. The method in accordance with claim 15, wherein determining the target camshaft rotation angle range comprises determining a first camshaft rotation angle range that corresponds to an opening ramp of the cam.

17. The method in accordance with claim 15, wherein
determining the target camshaft rotation angle range comprises determining a second camshaft rotation angle range that corresponds to a closing ramp of the cam.

18. The method in accordance with claim 13, wherein the engine also includes a rocker arm operably coupled to the cam, the method further comprising:
determining a rocker arm ratio of the rocker arm; and
determining the range of target camshaft rotation angles as a function of the rocker arm ratio.

19. The method in accordance with claim 18, wherein the engine also includes a tappet screw coupled to the rocker arm, the method further comprising determining the target camshaft rotation angle that facilitates translating the tappet screw towards a valve by a distance equal to the predetermined tappet clearance value.

20. A method of setting a tappet in an engine, the method comprising:
adjusting a tappet screw coupled to a cam such that a gap defined between a valve and the tappet screw is greater than a predetermined tappet clearance;
setting a crankshaft within a first range of crankshaft rotation angles, wherein the cam is coupled to the crankshaft, and the cam is configured to provide cam lobe lift when the crankshaft is set within the range of crankshaft rotation angles, wherein the cam lobe lift translates the tappet screw towards the valve by a distance less than the gap, wherein the distance corresponds to a predetermined tappet clearance value defined when the crankshaft is set within a second range of crankshaft rotation angles; and
adjusting the tappet screw such that a zero gap tappet clearance is defined between the valve and the tappet screw, wherein the predetermined tappet clearance is defined between the valve and the tappet screw when the cam does not provide the cam lobe lift.
